(19) United States
(12) Patent Application Publication
(10) Pub. No.: US 2014/0334784 A1
(43) Pub. Date: Nov. 13, 2014

(54) OPTICAL CONNECTOR

(71) Applicants: AUTONETWORKS TECHNOLOGIES, LTD, Yokkaichi (JP); SUMITOMO WIRING SYSTEMS, LTD., Yokkaichi (JP); SUMITOMO ELECTRIC INDUSTRIES, LTD., Osaka (JP)

(72) Inventor: Hiroshi TATEISHI, Yokkaichi (JP)

(73) Assignees: AUTONETWORKS TECHNOLOGIES, LTD, Yokkaichi (JP); SUMITOMO WIRING SYSTEMS, LTD., Yokkaichi (JP); SUMITOMO ELECTRIC INDUSTRIES, LTD., Osaka (JP)

(21) Appl. No.: 14/271,966

(22) Filed: May 7, 2014

(30) Foreign Application Priority Data
May 13, 2013 (JP) 2013-101086

(51) Int. Cl. G02B 6/42

(52) U.S. Cl. CPC G02B 6/4212; G02B 6/4298
USPC 385/93

(57) ABSTRACT

An optical connector, in which light propagating between both connectors is parallel light, capable of reducing splicing loss due to angular or axial displacement is provided. An optical connector includes a first connector that includes a collimating lens that collimates light emitted from a light emitting member into parallel light and a first fitting, and a second connector that includes a convergent lens that converges the parallel light emitted from the first connector toward a light incident member and a second fitting configured to be fitted to the first fitting, in which an inner circumferential surface of one of the fitting has a tapered surface that widens toward its front end, and an outer circumferential surface of the other of the fittings that comes into contact with the inner circumferential surface of one fitting has a tapered surface that narrows toward its front end.

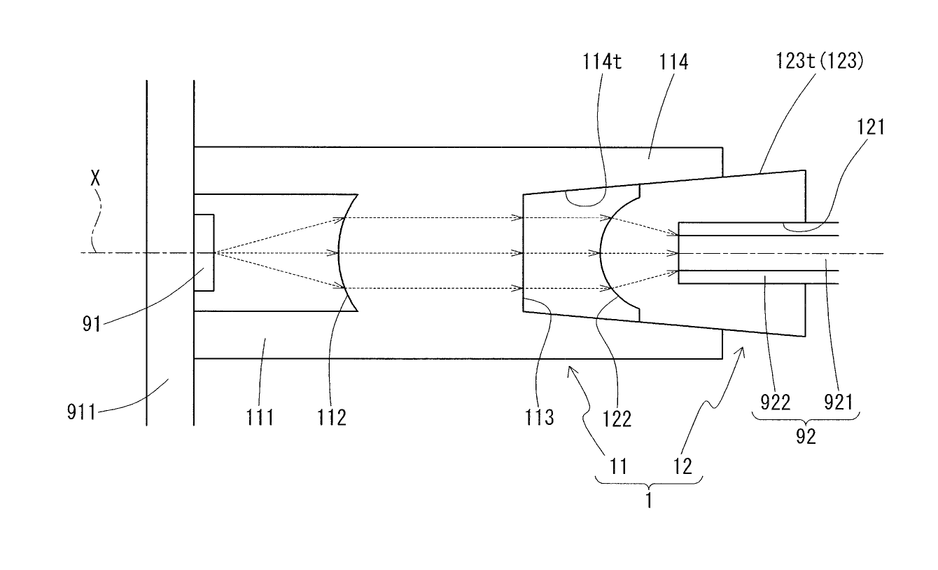

### BACKGROUND

The present disclosed embodiments relate to an optical connector that optically connects a light emitting member and a light incident member.

As described in JP 2007-41222A, optical connectors are known that have a configuration in which light emitted from a light emitting member propagates in a space between connectors and is incident on a light incident member. In the optical connector described in JP 2007-41222A, the light propagating in the space is controlled so as to be parallel light. In optical connectors in which the light propagating between two connectors (between the light emitting member and the light incident member) is controlled so as to be parallel light, splicing loss when the distance between the connectors in an optical axis direction changes is small compared to optical connectors in which the propagating light is not parallel light. That is, there is the advantage that the optical connector is robust even if there is positional displacement in the optical axis direction.

### SUMMARY

Although optical connectors in which the light propagating in the space is parallel light are robust even when there is positional displacement in an optical axis direction, there are problems that such optical connectors are not robust when there is “angular displacement” or when there is “axial displacement.” Angular displacement occurs when one connector is inclined with respect to the other connector. Axial displacement occurs when the optical axis of one connector is displaced from the optical axis of the other connector.

It is an object of the invention to provide an optical connector, in which light propagating between two connectors is parallel light, capable of reducing splicing loss due to angular displacement or axial displacement.

To solve the foregoing problems, the optical connector according to some aspects of the invention includes a first connector and a second connector. The first connector includes a collimating lens portion that collimates light emitted from a light emitting member into parallel light and a first fitting portion. The second connector includes a convergent lens portion that converges the parallel light emitted from the first connector toward a light incident member and a second fitting portion configured to be fitted to the first fitting portion. An inner circumferential surface of one of the first fitting portion and the second fitting portion has a tapered surface that widens toward its front end, and an outer circumferential surface of the other of the first fitting portion and the second fitting portion that comes into contact with the inner circumferential surface of the one fitting portion has a tapered surface that narrows toward its front end.

In the optical connector according to the present invention, the inner circumferential surface of one fitting portion (female) and the outer circumferential surface of the other fitting portion (male) that comes into contact with it are tapered. Therefore, when both connectors are fitted to each other, a gap is not likely to be formed between the inner circumferential surface of one fitting portion and the outer circumferential surface of the other fitting portion. Accordingly, it is possible to reduce splicing loss due to angle displacement or axis displacement. Moreover, since the optical connector has the configuration in which the tapered surfaces come into contact and are relatively positioned, positional displacement in an optical axis direction (variations in the distance between the connectors in the optical axis direction) is likely to occur. However, since light emitted from the first connector is parallel light, splicing loss is not increased due to the positional displacement in the optical axis direction.

### BRIEF DESCRIPTION OF THE DRAWING

The single drawing is a schematic cross-sectional view (hatching is omitted) of an optical connector according to an embodiment of the present invention.

### DETAILED DESCRIPTION OF EMBODIMENTS

Hereinafter, an optical connector 1 according to one embodiment will be described in detail with reference to the only drawing. The optical connector 1 according to this embodiment includes a first connector 11 (first connector component) and a second connector 12 (second connector component).

The first connector 11 is a connector into which a light emitting member is integrated, and is a member in which at least a portion thereof that serves as a path of light emitted from the light emitting member is formed of a light-transmissive material. In the first connector 11 of this embodiment, a light emitting element 91 (photoelectric converting element) serving as the light emitting member and a substrate 911 on which the element 91 is mounted are integrated into a single component. A tubular portion 111 is formed on a base side (the left side in the drawing) of the first connector 11. The end portion of this tubular portion 111 is connected to the substrate 911. That is, the first connector 11 is integrated with the light emitting element 91 via the substrate 911. It should be noted that the method for connecting the first connector 11 and the substrate 911 is not limited to any specific method. Examples of preferable methods include a method for connecting the first connector 11 and the substrate 911 by making the end portion of the tubular portion 111 of metal and soldering this metal portion to the substrate 911. The light emitting element 91 mounted on the substrate 911 is located inside the “tube”. The light emitting element 91 converts electric signals sent from a circuit formed on the substrate 911 to optical signals, and then, emits light from its light emitting portion.

A collimating lens portion 112 that collimates the light emitted from the light emitting element 91 is formed in the first connector 11. The optical axis of this collimating lens portion 112 coincides with the optical axis of the above-described light emitting element 91 (axis passing through the center of the light emitting portion). This collimating lens portion 112 collimates divergent light emitted from the light emitting element 91. In other words, the shape of the collimating lens portion 112 and the distance (such as the length of the tubular portion 111) between the collimating lens portion 112 and the light emitting element 91 in an optical axis direction are set as appropriate such that the light emitted from the light emitting element 91 becomes parallel light.

The light collimated by the collimating lens portion 112 passes the light-transmissive material constituting the first connector 11 and is emitted from a light emitting surface 113 that is perpendicular to the optical axis.

A first fitting portion 114 is formed in the first connector 11 further towards a front end of the first connector 11 (the right end of the first connector 11 in the drawing) with respect to the light emitting surface 113. The first fitting portion 114 is formed in a substantially tubular shape so as to surround the emitting surface. The inner circumferential surface of this first fitting portion 114 has a tapered surface 114t (angle θ1) that gradually widens toward the front end.

A second connector 12 is a connector into which a light incident member is integrated, and is a member in which at least a portion thereof that serves as a path of light that is incident on the light incident member is formed of a light-transmissive material. A fiber fixing hole 121 that recesses from a surface on the base end (the right end of the second connector 12 in the drawing) toward the front end (the left end of the second connector 12 in the drawing) is formed in the second connector 12. An optical fiber 92 (including a core 921 and cladding 922) that serves as the light incident member is fixed to this fiber fixing hole 121 using an adhesive or the like.

A convergent lens portion 122 that converges the parallel light emitted from the light emitting surface 113 in the first connector 11 described above is formed at the front end of the second connector 12. Specifically, the convergent lens portion 122 converges the parallel light that reaches the convergent lens portion 122 toward the core 921 of the optical fiber 92. That is, the shape of the convergent lens portion 122 and the distance between the convergent lens portion 122 and the front end of the core 921 of the optical fiber 92 (bottom surface of the fiber fixing hole 121) in an optical axis direction are set as appropriate such that all the parallel light that is incident on the convergent lens portion 122 enters the core 921 of the optical fiber 92.

The outer circumferential surface of the second connector 12 is a second fitting portion 123 that can be fitted to the first fitting portion 114 in the first connector 11 described above. In this embodiment, the outer circumferential surface of the second fitting portion 123 has a tapered surface 123t (angle θ2) that gradually tapers toward the front end.

The angle θ1 of the tapered surface 114t of the first fitting portion 114 in the first connector 11 is equal to the angle θ2 of the tapered surface 123t of the second fitting portion 123 in the second connector 12. Therefore, when the second fitting portion 123 in the second connector 12 is inserted into and pushed in the inside of the first fitting portion 114 in the first connector 11, both tapered surfaces come into contact and both connectors are relatively positioned. Thereby, the light emitting element 91 serving as the light emitting member and the optical fiber 92 serving as the light incident member are optically connected. It should be noted that when both connectors are positioned, their positions are set such that the convergent lens portion 122 in the second connector 12 does not come into contact with the light emitting surface 113 in the first connector 11.

With the optical connector 1 according to this embodiment having the above-described configuration, the following effect is exhibited.

Since the optical connector 1 according to this embodiment has a configuration in which the tapered surface 114t of the fitting portion 114 in the first connector 11 and the tapered surface 123t of the second connector 12 come into contact and are relatively positioned, angular displacement and axial displacement are not likely to occur. Therefore, it is possible to reduce splicing loss due to angular displacement and axial displacement.

In such a configuration in which tapered surfaces come into contact with each other and are relatively positioned, angular displacement and axial displacement are not likely to occur, but positional displacement in an optical axis direction (variations in the distance between the connectors in the optical axis direction) is likely to occur. However, in the optical connector 1 according to this embodiment, the light emitted from the light emitting surface 113 in the first connector 11 toward the second connector 12 is parallel light. Therefore, splicing loss is not increased due to the positional displacement in the optical axis direction.

Moreover, since the inner diameter of the front end of the first fitting portion 114 is larger than the outer diameter of the front end of the second fitting portion 123, both connectors can be easily fitted to each other.

While the embodiment of the present invention has been described in detail, the present invention is not limited to the above-described embodiment, and various modifications can be made without departing from the concept of the present invention.

Although it has been stated that, in the optical connector 1 according to the above-described embodiment, the inner circumferential surface of the first fitting portion 114 is a tapered surface 114t that gradually widens toward the front end and the outer circumferential surface of the second fitting portion 123 is a tapered surface 123t that gradually tapers toward the front end, an inversed configuration may be adopted.

Although it has been stated that the optical connector 1 according to the above-described embodiment optically connects the light emitting element 91 serving as the light emitting member and the optical fiber 92 serving as the light incident member, the light incident member and the light emitting member are only exemplifications. For example, the technical idea of the present invention can be also applied to an optical connector in which both the light emitting member and the light incident member are optical fibers (optical connector that optically connects optical fibers) or an optical connector in which the light emitting member is an optical fiber and the light incident member is a light receiving element that converts optical signals to electric signals (optical connector that optically connects an optical fiber and a light receiving element).

What is claimed is:

1. An optical connector comprising:
a first connector that includes
a collimating lens portion that collimates light emitted from a light emitting member into parallel light and,
a first fitting portion; and
a second connector that includes
a convergent lens portion that converges the parallel light emitted from the first connector toward a light incident member and,
a second fitting portion configured to be fitted to the first fitting portion, wherein
an inner circumferential surface of one of the first fitting portion and the second fitting portion has a tapered surface that widens toward its front end, and
an outer circumferential surface of the other of the first fitting portion and the second fitting portion that comes into contact with the inner circumferential surface of the one fitting portion has a tapered surface that narrows toward its front end.
